(19) United States
(12) Patent Application Publication
(10) Pub. No.: US 2008/0011878 A1
(43) Pub. Date: Jan. 17, 2008

(54) PORTABLE MISTING SYSTEM AND METHOD

(76) Inventor: Marc Maples, Scottsdale, AZ (US)

Correspondence Address: WEISS & MOY PC, 4204 NORTH BROWN AVENUE, SCOTTSDALE, AZ, 85251, US

(21) Appl. No.: 11/777,836

(22) Filed: Jul. 13, 2007

Related U.S. Application Data
(60) Provisional application No. 60/807,458, filed on Jul. 14, 2006.

(51) Int. Cl. B05B 15/06; B05B 15/10; B05B 1/20; A62C 31/24; B05B 1/14

(52) U.S. Cl. 239/281; 239/209; 239/207; 239/266; 239/279; 239/280; 239/550

(57) ABSTRACT

A portable misting system comprises a plurality of base members which may be coupled to a plurality of vertical support members, which, in turn, may be coupled to a plurality of horizontal frame members. A tubing apparatus including a plurality of mist nozzles runs through the horizontal frame members and at least one vertical support member and one base member. The tubing apparatus may be connected to a water supply and may include a water pump. Water flows through the tubing apparatus of the portable misting system and is dispersed from the mist nozzles to provide cooling benefit to a desired area. Light fixtures may be coupled to the portable misting system. The configuration of the portable misting system may be adjusted as desired to accommodate various spaces in which it may be installed.

### RELATED APPLICATION

This non-provisional application claims priority from provisional application No. 60/807,458, filed on Jul. 14, 2006.

### FIELD OF INVENTION

This invention relates generally to misting systems and methods therefor and, more particularly, to a misting system that is portable, that is capable of providing illumination, and that can be configured into multiple arrangements to provide maximum cooling benefit in various spaces in which it may be installed.

### BACKGROUND OF THE INVENTION

Misting systems are well known and are especially popular in warm climates. Misting systems are often installed in residential and commercial outdoor areas wherever cooling may be desired, such as in deck, patio, pool, and garden areas, and the like. Misting systems typically consist of a tubing apparatus connected to a water pump, which, in turn, is connected to a water supply, usually by a garden hose or the like. The tubing often has fine openings through which the water may be dispersed in the form of mist. Alternatively, nozzles may be connected to and spaced along the tubing, through which the mist may be dispersed.

Prior art misting systems include those that are permanently installed, as well as portable varieties. Permanent misting systems are often affixed to a building structure, such as a roof overhang, a portion of an outside wall, a deck railing, etc. Portable misting

systems may include a water supply and tubing apparatus attached to a fan that disperses the mist when the fan is in operation. When cooling is desired for more than one person, such fans are typically of a heavy duty variety and relatively large, in order to accommodate a relatively large area. When cooling is desired for an individual, such fans are typically lightweight and relatively small.

The prior art misting systems have certain limitations. With respect to the permanent misting systems, they are often labor intensive to set up, in that they must be affixed to a building structure in some manner. Another disadvantage with permanent misting systems is that they typically are not removed during the seasons in which they are not in use. A home owner or business owner may find such misting systems undesirable during such periods, in part because they may detract from the aesthetic appearance of the structure to which they are attached. With respect to portable misting systems, such systems are typically capable of providing cooling only to a limited area. In the case of misting fans, for example, if cooling for a larger space is desired, it is often necessary to set up multiple fans. This can be both costly and labor intensive. In addition, the larger misting fans are often heavy, cumbersome, and not aesthetically pleasing. Further, because misting systems are often used at night (as well as during the day), it is often desirable for the areas where the misting systems are installed to be illuminated. However, the typical prior art misting systems do not provide illumination. Instead, illumination must come from some other source, such as outdoor lighting fixtures. It would be especially convenient for the lighting to be incorporated into the misting system itself, as opposed to providing lighting from another location.

A need therefore exists for a misting system that is portable, that is capable of providing illumination, and that can be configured into multiple arrangements to provide maximum cooling benefit in various spaces in which it may be installed.

The present invention satisfies these needs and provides other, related advantages.

### SUMMARY OF THE INVENTION

The present invention resides in a portable misting system that is capable of providing illumination, and that can be configured into multiple arrangements to provide maximum cooling benefit in various spaces in which it may be installed. The portable misting system comprises, generally, at least two vertical support members each having a first end and a second end; a base member at the first end of each of the vertical support members; at least one horizontal frame member coupled proximate the second end of the at least two vertical support members; and tubing through the at least one horizontal frame member, and at least one vertical support member and base member, the tubing connectable to a pressurized water supply to disperse mist through a plurality of openings therein.

The base members may each comprise a substantially flat platform and an elongated vertical socket coupled thereto. Alternatively, the base members include a bucket-like covered receptacle or barrel, to which the vertical sockets may be are coupled. The receptacles may be filled (weighted) with a substance such as sand, cement, water, or the like, in order to help prevent shifting of the vertical sockets and to prevent the portable misting system from toppling over.

In one embodiment, the vertical sockets of the base members are hollow, in order to be able to receive the vertical support members. A plurality of openings may be provided in the vertical sockets that correspond to a plurality of openings in the vertical support members, through which coupling members may be inserted to secure the vertical support members to the vertical sockets

A first end of each vertical support member may be adapted to be inserted into one of the vertical sockets, while a second end of each vertical support member may be adapted to receive at least one horizontal frame member. In this embodiment, a support sleeve may be coupled to each vertical support member, in order to support and provide a resting point for the horizontal frame members that will be slidably attached to each vertical support member.

In another embodiment, a second vertical support member may be coupled to each of the vertical support members, in order to provide for a greater overall height for the portable misting system when fully assembled. A support sleeve having a diameter greater than the second end of the first vertical support member may be coupled to a second end of a first vertical support member, with a first end of the second vertical support member being inserted into the support sleeve. When second vertical support members are used, it is preferred to provide on the vertical support members a second plurality of openings that correspond to a plurality of openings (not shown) in the second vertical support members, through which a second set of coupling members may be inserted to secure the second vertical support members to the vertical support members.

Each horizontal frame member may consist of a three-sided elongated bar having two ends. The horizontal frame member may be adapted to house a length of tubing, which may be secured within the horizontal frame member with fasteners. The horizontal frame member may further comprise two connecting rings, with each end of the horizontal frame member having one connecting ring coupled thereto. An outer surface of each connecting ring may be coupled to an outer surface of each horizontal frame member, such that an opening in each connecting ring will be in an orientation that is substantially perpendicular to a ground below when the horizontal frame members are in position on the vertical support members. The connecting rings may be adapted to be slidably attached to the vertical support members.

The horizontal frame member may comprise two rotatable connecting rings. Each end of the horizontal frame member may have one rotatable connecting ring coupled therethrough as hereinafter described. A threaded bolt connected to the outer surface of the rotatable connecting ring may extend through a drilled opening in the horizontal frame member and be secured therethrough by a locking nut. Rotation of the locking nut permits rotation or swiveling of the connecting ring. This arrangement permits the connecting ring to be rotated or swiveled to orient the opening in each connecting ring to the desired position when the horizontal frame members are in position on the vertical support members. The rotatable connecting rings substantially allow placement of the portable misting system on an uneven surface and still be able to stand substantially vertically.

When the portable misting system is fully assembled, the horizontal frame members may form different shapes to accommodate various spaces in which it may be installed.

The tubing apparatus comprises the following components: a length of connector tubing running through at least one base member and at least one vertical support member, a length of tubing running through and secured within each of the horizontal frame members, corner connector tubing, which is used to connect the tubing of adjacently situated horizontal frame members, and a plug inserted in a closed end of the tubing apparatus. Each end of the tubing may be equipped with an attachment mechanism, whereby corner connector tubing may be attached to the tubing of adjacently situated horizontal frame members. The connector tubing and corner connector tubing are preferably composed of a flexible material such as nylon, rubber, plastic, or some other desired material. The tubing running through each of the horizontal frame members is preferably comprised of stainless steel or copper and may include a plurality of attachment points to which a plurality of mist nozzles may be attached. The attachment points and mist nozzles may be spaced at even or uneven intervals throughout the length of the tubing.

The portable misting system may also include a plurality of light fixtures, which may be adapted to be coupled to a plurality of the vertical support members

The connector tubing of the tubing apparatus of the portable misting system may be connected to a water pump which, in turn, is connected indirectly to a water supply by a garden hose. When the portable misting system is fully assembled and the water pump and water supply are engaged, water should flow through the tubing apparatus of the portable misting and as water reaches each mist nozzle, mist should flow from the mist nozzles, providing the cooling benefit to the area in which the portable misting system is installed.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view of a portable misting system, consistent with an embodiment of the present invention.

FIG. 2 is a perspective view of a base member and portion of a vertical support member of the portable misting system of FIG. 1.

FIG. 3 is a perspective view of an upper portion of a vertical support member of the portable misting system of FIG. 1.

FIG. 4 is a perspective view of an upper portion of a vertical support member of a portable misting system, consistent with an embodiment of the present invention.

FIG. 5 is a perspective view of an upper corner portion of a portable misting system, consistent with an embodiment of the present invention.

FIG. 6 is a perspective view of an upper corner portion of a portable misting system, consistent with an embodiment of the present invention.

FIG. 7 is a perspective view of an upper corner portion of a portable misting system consistent with an embodiment of the present invention.

FIG. 8 is a perspective view of an upper corner portion of a portable misting system, consistent with an embodiment of the present invention.

FIG. 9 is a perspective view of the base member and portion of the vertical support member (shown in phantom) of FIG. 2, in a configuration consistent with an embodiment of the present invention.

FIG. 10 is a perspective view of the base member and portion of the vertical support member of FIG. 9.

FIG. 11 is a perspective view of the base member and portion of the vertical support member of FIG. 2, in a configuration consistent with an embodiment of the present invention.

FIG. 12 is a perspective view of a base member and vertical support members of a portable misting system, in a configuration consistent with an embodiment of the present invention.

FIG. 13 is a perspective view of a base member and vertical support members of a portable misting system, in a configuration consistent with an embodiment of the present invention.

FIG. 14 is a perspective view of a portion of tubing and an unassembled nozzle of a portable misting system, consistent with an embodiment of the present invention.

FIG. 15 is a perspective view of the tubing and nozzle of FIG. 14, in an assembled position.

FIG. 16 is a top view of a vertical support member and horizontal frame members of a portable misting system, consistent with an embodiment of the present invention.

FIG. 17 is a perspective view of the vertical support member and horizontal frame members of FIG. 16.

FIG. 18 is a top view of vertical support members and horizontal frame members of a portable misting system, consistent with an embodiment of the present invention.

FIG. 19 is a top view of vertical support members and horizontal frame members of a portable misting system, consistent with an embodiment of the present invention.

FIG. 20 is a perspective view of a portable misting system, consistent with an embodiment of the present invention.

FIG. 21 is a perspective view of a portion of a portable misting system, consistent with an embodiment of the present invention.

FIG. 22 is a side view of a base member of a portable misting system, with a portion of a vertical support member thereof being shown in phantom, consistent with an embodiment of the present invention.

FIG. 23 is a side, cutaway view of the base member and vertical support member of FIG. 22.

FIG. 24 is a side view of a portion of a vertical support member of a portable misting system, with a base member thereof being shown in phantom, consistent with an embodiment of the present invention.

FIG. 25 is a perspective view of a base member coupled to a vertical support member of a portable misting system, in a configuration consistent with an embodiment of the present invention.

FIG. 26 is a side perspective view of a swivable connecting ring assembly of a portable misting system, illustrating the connecting ring in an upright position.

FIG. 27 is another side perspective view of the connecting ring assembly of FIG. 26 with the connecting ring oriented in a different position.

FIG. 28 is another side perspective view of the connecting ring assembly of FIGS. 26-27 with the connecting ring oriented in another position.

FIG. 29 is another side perspective view of the connecting ring assembly of FIGS. 26-28 with the connecting ring oriented in yet another position.

FIG. 30 is a perspective view of a portable misting system, consistent with an embodiment of the present invention.

### DETAILED DESCRIPTION OF THE PREFERRED EMBODIMENTS

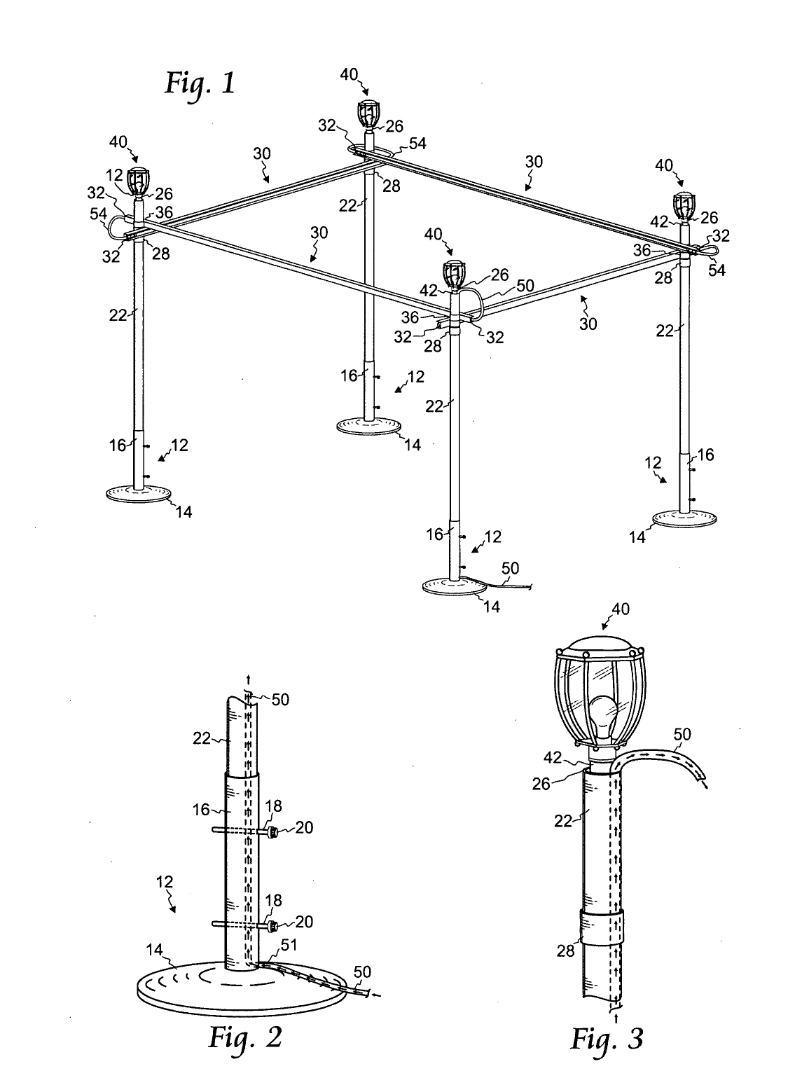

Referring first to FIG. 1, an embodiment of a portable misting system 10 consistent with an embodiment of the present invention is shown. The structure for the portable misting system 10 can be divided into the following principle components: a plurality of base members 12, each adapted to receive and be coupled to a plurality of horizontally spaced elongated vertical support members 22, each of which is, in turn, adapted to receive and be coupled to a plurality of horizontal frame members 30 and a plurality of light fixtures 40. The portable misting system 10 further comprises a tubing apparatus, including a length of connector tubing 50 running through at least one base member 12 and at least one vertical support member 22, a length of tubing 52 running through each of the horizontal frame members 30, and corner connector tubing 54, connecting the tubing 52 of adjacently situated horizontal frame members 30. Preferably, the base members 12, vertical support members 22, horizontal frame members 30, and tubing 52 of the portable misting system 10 are composed of a sturdy material, such as brass, copper, steel, stainless steel or aluminum, but could also be composed of plastic, rubber or some other desired material.

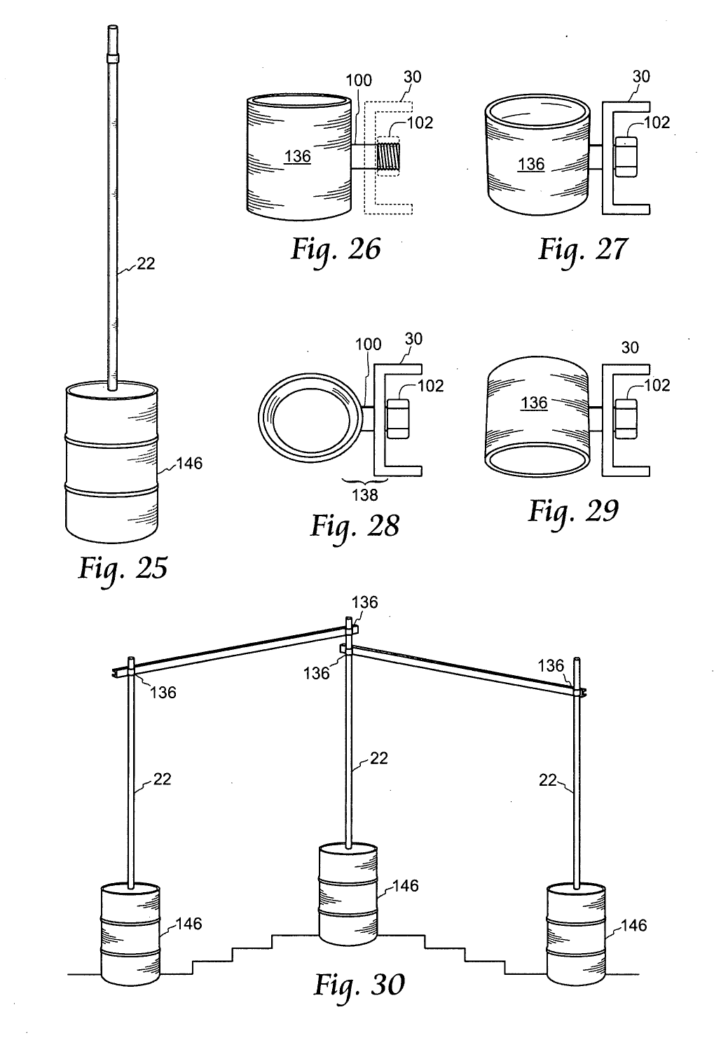

With respect to the base members 12, in this embodiment, the base members 12 each comprise a substantially flat platform 14 and an elongated vertical socket 16 coupled thereto. (A representative example of a base member 12 is best seen in detail in FIG. 2.) In this embodiment, the platforms 14 have a substantially circular shape. However, it may be desired for the platforms 14 to have a different shape, such as a square, rectangle, triangle, etc. In another embodiment, show in FIGS. 22-24, instead of a platform 14, the base members 12 include a bucket-like covered receptacle 14a or barrel 14b (FIGS. 25 and 30), to which the vertical sockets 16 are coupled. The receptacles 14a may be filled (weighted) with a substance such as sand, cement, or the like, in order to help prevent shifting of the vertical sockets 16 and to prevent the portable misting system 10 from toppling over.

Referring now to FIGS. 9-11, in one embodiment, the vertical sockets 16 of the base members 12 are hollow, in order to be able to receive the vertical support members 22. A diameter of the vertical sockets 16 should be slightly greater than a diameter of the vertical support members 22, in order that the vertical support members 22 may be inserted in the vertical sockets 16 and coupled thereto. It is preferred to provide on the vertical sockets 16 a plurality of openings 18 that correspond to a plurality of openings (not shown) in the vertical support members 22, through which coupling members 20 may be inserted to secure the vertical support members 22 to the vertical sockets 16. While in this embodiment a total of four openings 18 are provided in each vertical socket 16, additional openings could be used, if desired. The coupling members 20 may consist of bolts, screws, pins, or the like. It is further preferred to provide on at least one vertical socket 16 an opening proximate the platform 14 through which connector tubing 50 may be inserted (as discussed below).

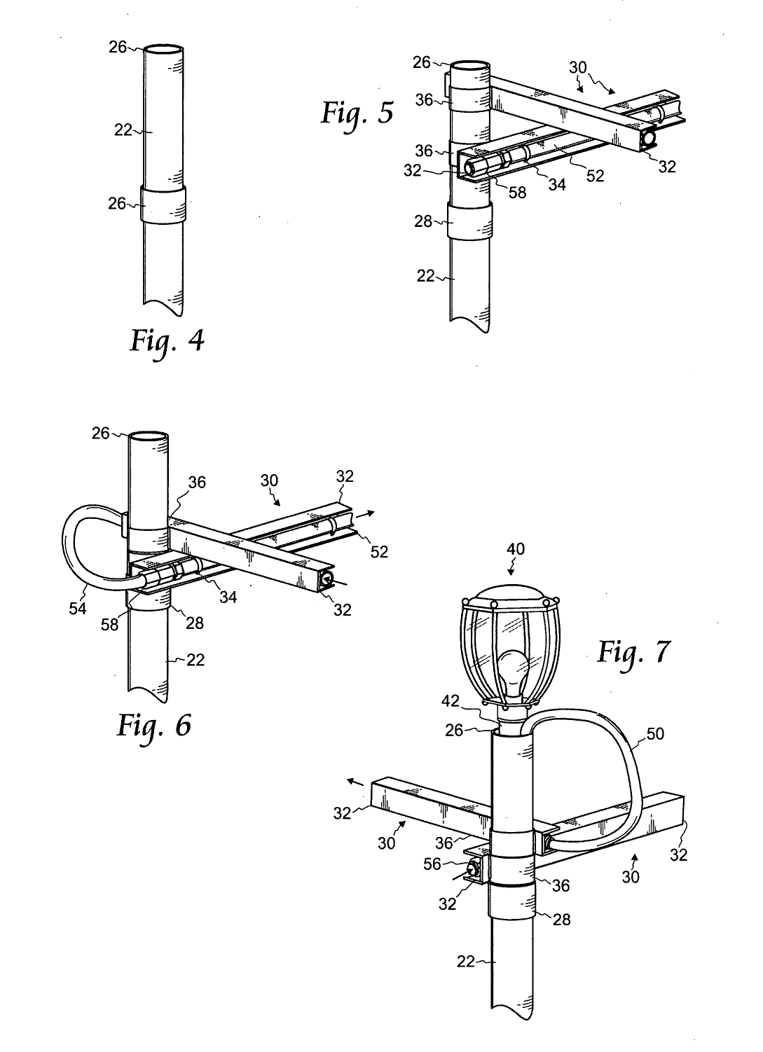

The vertical support members 22 preferably consist of hollow, elongated poles, each having a first end 24 (seen in FIGS. 9 and 11-13) and a second end 26 (seen in FIGS. 1, 3-8, and 17). The first end 24 of each vertical support member 22 is preferably adapted to be inserted into one of the vertical sockets 16 (as discussed above), while the second end 26 of each vertical support member 22 is preferably adapted to receive at least one horizontal frame member 30 (to be discussed below). In this embodiment, a support sleeve 28 is coupled to each vertical support member 22, in order to support and provide a resting point for the horizontal frame members 30 that will be slidably attached to each vertical support member 22. While a support sleeve 28 is included in a preferred embodiment, it may be desired to provide a resting point for the horizontal frame members 30 in some other manner, such as by inserting a plurality of screws, bolts, or the like through the vertical support members 22. It is preferred for the vertical support members 22 to be of a sufficient length, such that when the portable misting system 10 is fully assembled, an overall height of the portable misting system 10 is greater than a height of outdoor furniture which may be positioned thereunder, such as an umbrella stand 70 and chars 72 (as shown in FIG. 20). The overall height of the portable misting system 10 should also be greater than the heights of individuals who may walk underneath it. The portable misting system 10 may be adjusted to an overall greater height by aligning only one set of openings 18 (as opposed to two sets of openings 18) on the vertical sockets 16 with one set of openings (not shown) on the vertical support members 22, as demonstrated in FIG. 11.

While in a preferred embodiment the base members 12 and vertical support members 22 are separate components, it may be desired to configure a portable misting system 10 in which the base members 12 and vertical support members 22 comprise a one-piece assembly.

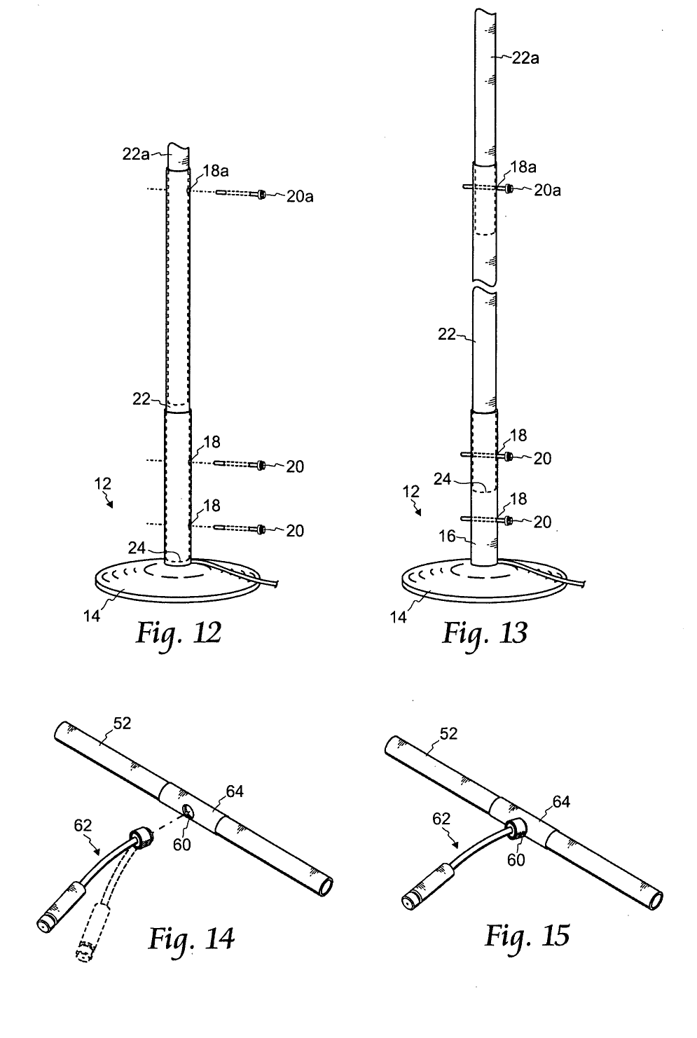

Referring now to FIGS. 12-13, in another embodiment, a second vertical support member 22a may be coupled to each of the vertical support members 22, in order to provide for a greater overall height for the portable misting system 10 when fully assembled. A diameter of the second vertical support members 22a should be slightly less than a diameter of the vertical support members 22, in order that the second vertical support members 22a may be inserted in the vertical support members 22. When second vertical support members 22a are used, it is preferred to provide on the vertical support members 22 a second plurality of openings 18a that correspond to a plurality of openings (not shown) in the second vertical support members 22a, through which a second set of coupling members 20a may be inserted to secure the second vertical support members 22a to the vertical support members 22. As with the coupling members 20, the second coupling members 20a may consist of bolts, screws, pins, or the like. Again, the portable misting system 10 may be adjusted to an overall greater height by aligning only one set of openings 18 on the vertical sockets 16 with one set of openings (not shown) on the vertical support members 22, as demonstrated in FIG. 13.

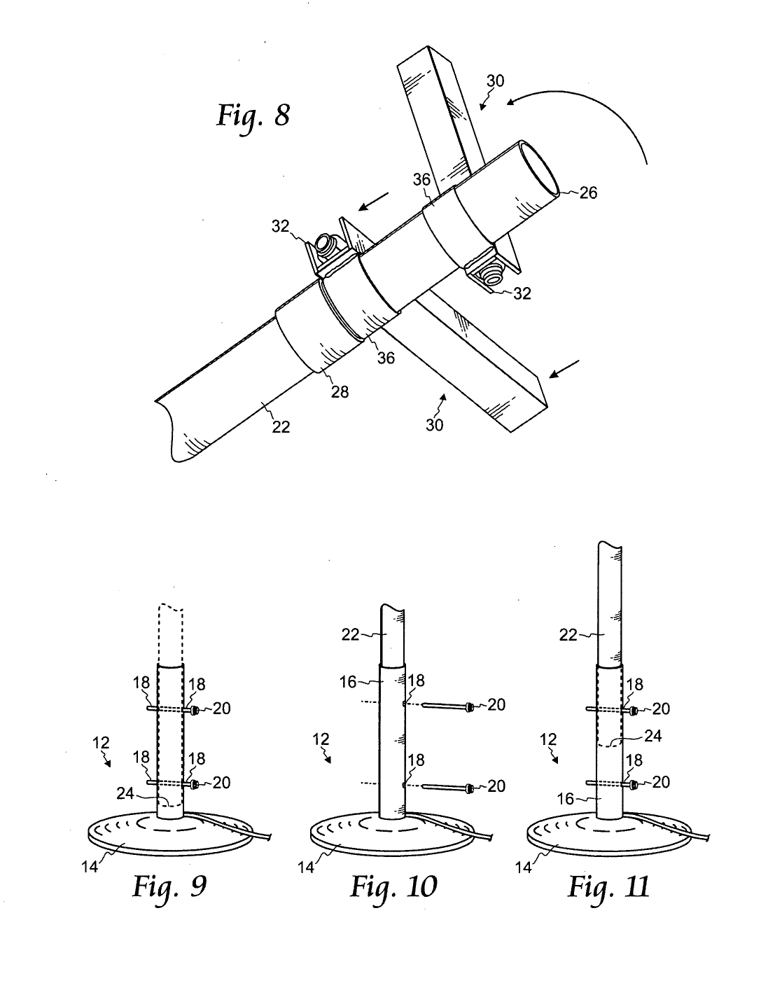

Turning now to the horizontal frame members 30 of the portable misting system 10, in the embodiment shown in FIGS. 1 and 20, each horizontal frame member 30 consists of a three-sided elongated bar having two ends 32. When viewed from either of the ends 32, it can be seen that the horizontal frame member 30 in this embodiment forms substantially a C shape, as best demonstrated in FIGS. 5-8. The horizontal frame member 30 is preferably adapted to house a length of tubing 52, which may be secured within the horizontal frame member 30 with fasteners 34, as best seen in FIGS. 5-6. In the embodiment shown in FIG. 1, the horizontal frame member 30 further comprises two connecting rings 36. Each end 32 of the horizontal frame member 30 further comprises two connecting rings 36. Each end 32 of the horizontal frame member 30 has one connecting ring 36 coupled thereto. The connecting rings 36 preferably have a width that is substantially the same as a width of the sides of the horizontal frame members 30. Preferably, an outer surface of each connecting ring 36 is coupled to an outer surface of each horizontal frame member 30, such that an opening in each connecting ring 36 will be in an orientation that is substantially perpendicular to a ground below when the horizontal frame members 30 are in position on the vertical support members 22. The connecting rings 36 are adapted to be slidably attached to the vertical support members 22, as demonstrated in FIG. 8. Accordingly, a diameter of each connecting ring 36 should be slightly greater than a diameter of each vertical support member 22. As FIG. 8 demonstrates, each connecting ring 36 is adapted to rest on one of the support sleeves 28 or on a connecting ring 36 of another horizontal frame member 30.

In an alternative embodiment shown in FIGS. 25-30, the horizontal frame member 30 may comprise two rotatable connecting rings 136. Each end 32 of the horizontal frame member 30 may have one rotatable connecting ring 136 coupled therethrough as hereinafter described. The rotatable connecting rings 136 preferably have a width substantially double the width of the connecting rings 36. Preferably, a rotatable connecting ring assembly 138 comprises a threaded bolt 100 coupled by welding or the like to an outer surface of each rotatable connecting ring 136 and extending through a drilled opening (not shown) (FIG. 26) in the horizontal frame member 30 and rotatable therein by a locking nut 102. Rotation of the locking nut permits rotation of the connecting ring 136. This arrangement permits the connecting ring to be rotated or swiveled to orient the opening in each connecting ring 136 to the desired position when the horizontal frame members 30 are in position on the vertical support members 22. The opening in each connecting ring 136 is adapted to be slidably attached over the second ends of the vertical support members 22, as shown in FIG. 30. Accordingly, a diameter of each connecting ring 136 should be slightly greater than a diameter of each vertical support member 22. The rotatable connecting rings 136 substantially allow placement of the portable misting system on an uneven surface (such as shown in FIG. 30) and still be able to stand substantially vertically.

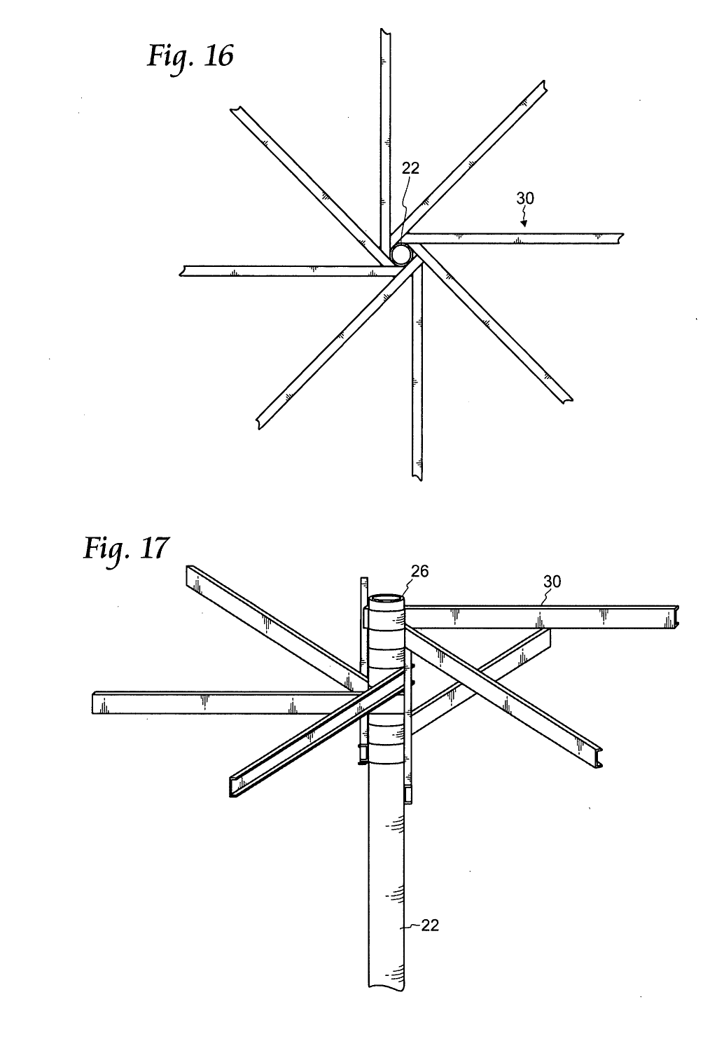

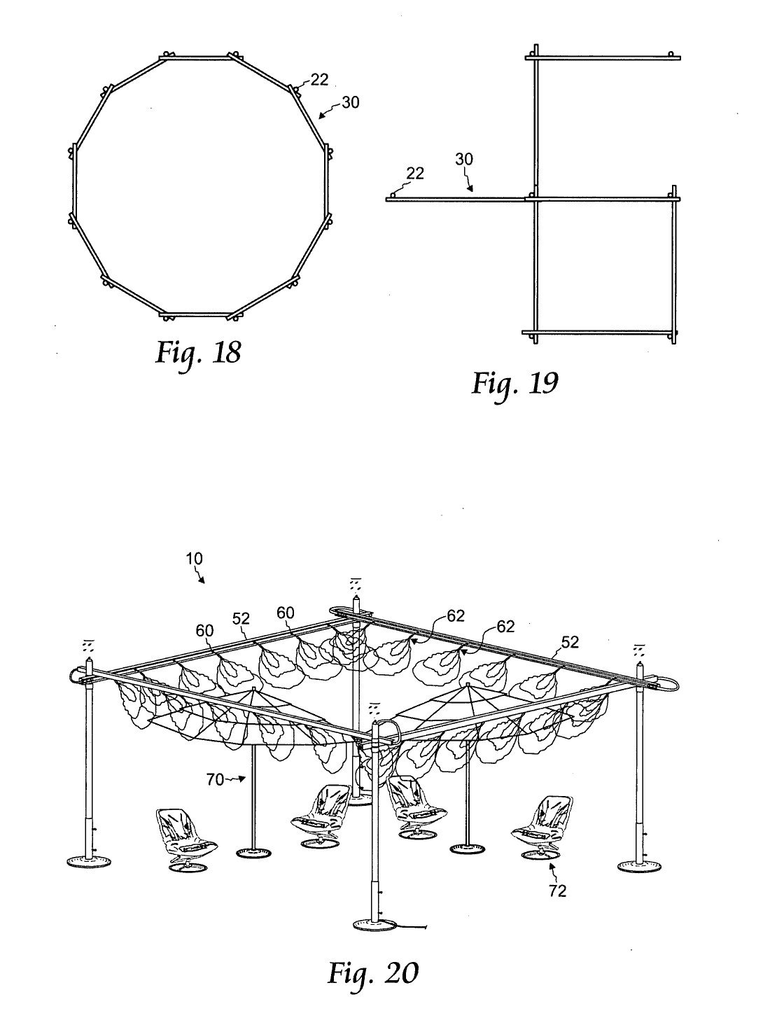

In the embodiment shown in FIGS. 1 and 20, when the portable misting system 10 is fully assembled, the horizontal frame members 30 form substantially a rectangular shape. In other embodiments, as shown in FIGS. 16-19, the horizontal frame members 30 form other shapes. It should be recognized that the horizontal frame members 30 may be configured into many different shapes imaginable, as desired. In this way, the portable misting system 10 may be configured to accommodate various spaces in which it may be installed. In addition, the portable misting system 10 may be configured to provide a decorative effect, such as a sun or star configuration, such as what is shown in FIG. 16.

Turning now to the tubing apparatus of the portable misting system 10, as seen in FIG. 1, in a preferred embodiment, the tubing apparatus comprises the following components: a length of connector tubing 50 running through at least one base member 12 and at least one vertical support member 22, a length of tubing 52 running through and secured within each of the horizontal frame members 30, corner connector tubing 54, which is used to connect the tubing 52 of adjacently situated horizontal frame members 30, and a plug 56 inserted in a closed end 32 of the tubing apparatus (as best seen in FIG. 7). With respect to the tubing 52 running through the horizontal frame members 30, preferably each end of the tubing 52 is equipped with an attachment mechanism 58, whereby corner connector tubing 54 may be attached to the tubing 52 of adjacently situated horizontal frame members 30, as seen in FIG. 6. With respect to the connector tubing 50, preferably it is of a sufficient length such it may attach to the tubing 52 of a horizontal frame member 30 and be threaded through at least one vertical support member 22 and at least one base member 12. Preferably, at least on base member 12 includes an opening 51 through which the connector tubing 50 may be inserted. (FIGS. 2 and 3 demonstrate a preferred embodiment in which the connector tubing 50 is threaded through a base member 12 and a vertical support member 22, respectively.) The connector tubing 50 and corner connector tubing 54 are preferably composed of a flexible material such as nylon, rubber, plastic, or some other desired material. The tubing 52 running through each of the horizontal frame members 30 is preferably comprised of stainless steel, although it should be clear that rubber, nylon, plastic or some other desired material may be used. In a preferred embodiment, the tubing 52 includes a plurality of attachment points 60 to which a plurality of mist nozzles 62 may be attached. FIGS. 14 and 15 demonstrate a preferred embodiment of the attachment points 60 and mist nozzles 62. In the embodiment shown in FIGS. 14-15, a sleeve 64 is coupled to the tubing 52, surrounding the attachment point 60, in order to provide structural support. However, the sleeve 64 may be omitted, if desired. In a preferred embodiment, as shown in FIG. 20, the attachment points 60 and mist nozzles 62 are spaced at even intervals throughout the length of the tubing 52, although it would be possible to space the attachment points 60 and mist nozzles 62 at uneven intervals, if desired.

A preferred embodiment of the portable misting system 10 also includes a plurality of light fixtures 40, which are adapted to be coupled to a plurality of the vertical support members 22, as seen in FIGS. 1, 3, 7, and 21. In the embodiment show in FIGS. 1, 3, 7, and 21, the light fixture 40 is coupled to a pole 42, which, in turn, is inserted through an opening in the second end 26 of the vertical support member 22. However, it may be desired to attach the light fixture 40 to the portable misting system 10 in some other manner. It may also be desired to construct a portable misting system 10 in which the light fixtures 40 are omitted.

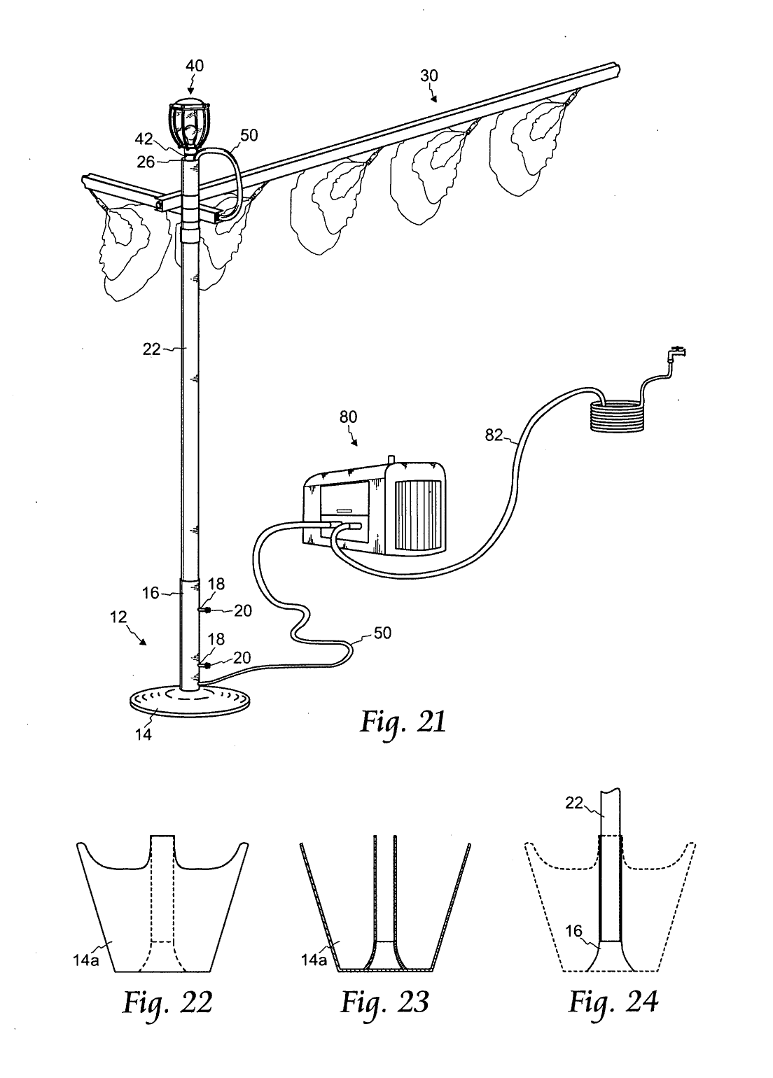

Referring now to FIG. 21, in a preferred embodiment, the connector tubing 50 of the tubing apparatus of the portable misting system 10 is connected to a water pump 80, which, in turn, is connected indirectly to a water supply by a garden hose 82. When the portable misting system 10 is fully assembled and the water pump 80 and water supply are engaged, water should flow through the tubing apparatus of the portable misting system 10 in a direction shown by the arrows in FIGS. 2, 3, and 6. As shown in FIG. 20, as water reaches each mist nozzle 62, mist should flow from the mist nozzles 62, providing the cooling benefit to the area in which the portable misting system 10 is installed.

While the invention has been particularly shown and described with reference to the preferred embodiments thereof, it will be understood by those skilled in the art that the foregoing and other changes in form and details may be made therein without departing from the spirit and scope of the invention.

I claim:

1. A portable misting system, comprising:
at least two vertical support members each having a first end and a second end;
a base member at the first end of each of the vertical support members;
at least one horizontal frame member coupled proximate the second end of the at least two vertical support members;
tubing through the at least one horizontal frame member, and at least one vertical support member and base member, the tubing connectable to a pressurized water supply to disperse mist through a plurality of openings therein.

2. The portable misting system of claim 1, wherein the tubing through the at least one horizontal frame member includes the plurality of openings and is connected to the tubing within the at least one vertical support member and base member.

3. The portable misting system of claim 2, wherein the at least one base member includes an opening through which the tubing is inserted.

4. The portable misting system of claim 1, wherein corner connector tubing connects the tubing of adjacently situated horizontal frame members.

5. The portable misting system of claim 1, further comprising at least one sleeve surrounding at least a portion of the tubing through the at least one horizontal frame member and adapted to support at least one of a plurality of nozzles, the plurality of nozzles in fluid communication with the plurality of openings in the tubing.

6. The portable misting system of claim 1, further comprising at least one light fixture coupled to the second end of at least one vertical support member.

7. The portable misting system of claim 1, wherein the base member comprises a substantially flat platform and an elongated vertical socket for receiving and coupling the first end of the first vertical support member, the elongated vertical socket and the first end of the first vertical support member each having a first plurality of openings, wherein at least one opening in the first end of the first vertical support member and in the elongated vertical socket are aligned to receive at least one coupling member therethrough.

8. The portable misting system of claim 7, wherein each vertical support member comprises a first vertical support member with a second plurality of openings at a second end and a second vertical support member with a plurality of openings at a first end, the first end of the second vertical support member received in and coupled to the second end of the first vertical support member, wherein at least one of the second plurality of openings in the first vertical support member and at least one of the plurality of openings in the second vertical support member are aligned to receive at least one coupling member therethrough.

9. The portable misting system of claim 1, wherein the base member comprises a substantially flat platform and an elongated vertical socket for receiving and coupling the first end of each vertical support member, the elongated vertical socket and the first end of each vertical support member each having a first plurality of openings, wherein at least one opening in the first end of each of the vertical support members and in the elongated vertical socket are aligned to receive at least one coupling member therethrough.

10. The portable misting system of claim 9, wherein each vertical support member comprises a first vertical support member with a second plurality of openings at a second end and a second vertical support member with a plurality of openings at a first end, the first end of the second vertical support member received in and coupled to the second end of the first vertical support member, wherein at least one of the second plurality of openings in the first vertical support member and at least one of the plurality of openings in the second vertical support member are aligned to receive at least one coupling member therethrough.

11. The portable misting system of claim 1, wherein the base member comprises a weighted barrel.

12. The portable misting system of claim 1, wherein the base member and each vertical support member comprise a one-piece assembly.

13. The portable misting system of claim 1, wherein the at least one horizontal frame member comprises a three-sided elongated bar.

14. The portable misting system of claim 1, wherein the at least one horizontal frame member further comprises a connecting ring coupled proximate each end thereof to receive the second end of each vertical support member therethrough.

15. The portable misting system of claim 14, wherein the connecting ring is rotatably coupled proximate each end of the at least one horizontal frame member.

16. A portable misting system, comprising:
a plurality of base members;
a plurality of vertical support members each adapted to be received and coupled to the plurality of base members;
a plurality of horizontal frame members each adapted to be received and coupled to the plurality of vertical support members;
a tubing apparatus comprising: a length of connector tubing running through at least a portion of at least one base member, and at least one vertical support member, a length of tubing running through each of the plurality of horizontal frame members, and corner connector tubing connecting the tubing of adjacently situated horizontal frame members, the tubing apparatus connectible to a pressurized water supply to disperse mist through a plurality of nozzles in said length of tubing running through each of the plurality of horizontal frame members; and
at least one light fixture coupled to the portable misting system.

17. The portable misting system of claim 16, wherein the plurality of base members comprise a substantially flat platform and an elongated vertical socket for receiving and coupling a first end of the plurality of vertical support members, the elongated vertical socket and the first end of the plurality of vertical support members each having a first plurality of openings, wherein at least one opening in the first end of the plurality of vertical support members and in the elongated vertical socket are aligned to receive at least one coupling member therethrough.

18. The portable misting system of claim 17, wherein each of the plurality of vertical support members comprise a first vertical support member with a second plurality of openings at a second end and a second vertical support member with a plurality of openings at a first end, the first end of the second vertical support member received in and coupled to the second end of the first vertical support member, wherein at least one of the second plurality of openings in the first vertical support member and at least one of the plurality of openings in the second vertical support member are aligned to receive at least one coupling member therethrough.

19. The portable misting system of claim 16, wherein the plurality of horizontal frame members further comprise a connecting ring coupled proximate each end thereof to receive the second end of each vertical support member therethrough.

20. A method of cooling an area with a portable misting system, comprising the steps of:
providing at least two vertical support members each having a first end and a second end, a plurality of base members the number corresponding to the number of vertical support members and at least one horizontal frame member;
providing at least one length of tubing through at least one vertical support member and each of the at least one horizontal frame members, the at least one length of tubing through the at least one horizontal frame member having a plurality of nozzles;
assembling the portable misting system by coupling a base member to the first end of each vertical support member and coupling at least one horizontal frame member proximate a second end of each of the vertical support members;
inserting and connecting the at least one length of tubing through each of the at least one horizontal frame members and at least one vertical support member;
arranging said plurality of base members in a configuration defining the outdoor area to be cooled;
connecting the connected tubing to a pressurized water supply; and
activating said pressurized water supply to disperse mist through the plurality of nozzles to cool the defined outdoor area.
